(19) United States
(12) Patent Application Publication
(10) Pub. No.: US 2023/0081565 A1
(43) Pub. Date: Mar. 16, 2023

(54) DISC BLADES ON WALKING TANDEM MOUNTING

(71) Applicant: CNH Industrial America LLC, New Holland, PA (US)

(72) Inventor: Michael George Kovach, Morton, IL (US)

(73) Assignee: CNH Industrial America LLC

(21) Appl. No.: 17/477,050

(22) Filed: Sep. 16, 2021

(51) Int. Cl. A01B 5/04; A01B 15/16

(52) U.S. Cl. CPC A01B 5/04; A01B 15/16

(57) ABSTRACT

A tilling implement is provided. The tilling implement includes a row bar and a mounting bracket coupled to the row bar. The tilling implement also includes a pair of disc blades coupled to the mounting bracket via a tandem mount, wherein the pair of disc blades are axially offset from each other along a longitudinal axis of the tandem mount.

### BACKGROUND

The disclosure relates generally to tillage implements and, in particular, to tillage implements utilizing disc blades on a walking tandem mounting.

A wide range of agricultural implements have been developed and are presently in use for tilling, cultivating, harvesting and so forth. Tillage implements, for example, are commonly towed behind tractors and may cover wide swaths of ground which may include various types of residue. Such residue may include materials left in the field after the crop has been harvested. These residues typically include stalks and stubble, leaves and seed pods. Good management of field residues can increase efficiency of irrigation and control of erosion in the field.

Certain agricultural implements include ground engaging tools configured to interact with the soil. For example, a tillage implement may include gangs of disc blades configured to break up the soil for subsequent planting or seeding operations. The configuration of the tilling implement gangs and their constituent discs will determine the quality and quantity of the passes required to effectively till an area of soil.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In one embodiment, a tilling implement is provided. The tilling implement includes a row bar and a mounting bracket coupled to the row bar. The tilling implement also includes a pair of disc blades coupled to the mounting bracket via a tandem mount, wherein the pair of disc blades are axially offset from each other along a longitudinal axis of the tandem mount.

In another embodiment, a ground working implement is provided. The ground working implement includes a row bar and multiple mounting brackets coupled to the row bar. The ground working implement also includes a respective pair of disc blades coupled to each mounting bracket of the multiple mounting brackets via a respective tandem mount, wherein each tandem mount is configured to pivot about a respective connection point with a respective mounting bracket.

In a further embodiment, a ground working tool configured to couple to an implement is provided. The ground working tool includes a mounting bracket. The ground working tool also includes a tandem mount coupled to the mounting bracket via a pivot joint configured to enable the tandem mount to rotate relative to the mounting bracket. The ground working tool further includes a pair of disc blades coupled to the tandem mount, wherein the pair of disc blades are axially offset from each other along a longitudinal axis of the tandem mount.

### DRAWINGS

These and other features, aspects, and advantages of the present disclosure will become better understood when the following detailed description is read with reference to the accompanying drawings in which like characters represent like parts throughout the drawings, wherein:

FIG. 1 is a partial top view of an embodiment of an implement having disc blades on walking tandem mounting;

FIG. 2 is a perspective view of an embodiment of a ground working tool (e.g., tandem mounted disc blades);

FIG. 3 is a schematic view of an embodiment of a connection point centrally located along a tandem mount;

FIG. 4 is a schematic view of an embodiment of a connection point located closer to one end of a tandem mount;

FIG. 5 is a side view of the ground working tool of FIG. 2;

FIG. 6 is a front view of a disc row including a plurality of ground working tools of FIG. 2;

FIG. 7 is a perspective view of the disc row of FIG. 6;

FIG. 8 is a top view of the disc row of FIG. 6 (with rotational axes of disc blades perpendicular to a direction of travel); and

FIG. 9 is a top view of the disc row of FIG. 6 (with rotational axes of disc blades angled at an oblique angle relative to a direction of travel).

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is generally directed to a tool (e.g., ground working tool for an implement (e.g., tillage or ground working implement). The tool includes a mounting bracket (e.g., configured to deflect to enable movement in a vertical direction relative to a direction of travel of the implement) and a pair of disc blades (e.g., fluted-concave disc blades) coupled to the mounting bracket via a tandem mount. The disc blades mounted on the tandem mount are axially offset from each other along a longitudinal axis of the tandem mount. In certain embodiments, respective vertical axes of the disc blades may be disposed at a cambered angle (e.g., greater than 0 degrees) relative to a vertical axis of the mounting bracket to reduce the backside pressure of the disc blades. The angles of the disc blades (e.g., angles of attack) may be adjusted relative to the direction of travel. The tandem mount is configured to pivot relative to the mounting bracket. This type of mounting on a single hanging framework enables the disc blades to move up and down (and walk over obstacles) while maintaining a consistent depth as the angle of the disc blades are adjusted by an operator. In addition, mounting of the blades in pairs enables more uniform indexing among multiple ranks of blades as the angle of attack is adjusted.

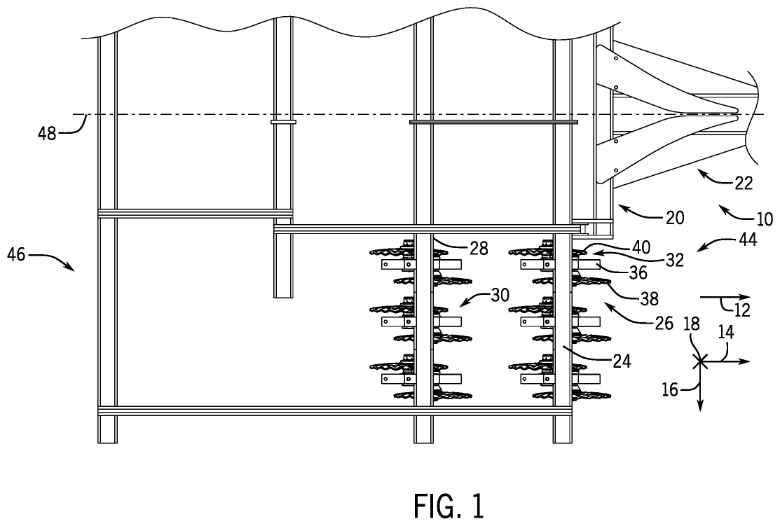

Referring now to the drawings, FIG. 1 is a partial top view of an agricultural implement 10 (e.g., tillage implement or ground working implement) having disc blades on walking tandem mounting. Certain elements of the implement are not shown (e.g., transport wheels, etc.). The implement 10 may be towed by a tractor in a direction of travel 12. The implement 10 and its components may be described with reference to an axial axis or direction 14, a lateral axis or direction 16, and a vertical axis or direction 18.

The implement 10 includes a frame 20 (e.g., main frame) that includes a hitch assembly 22 for coupling the implement 10 to the tractor. The frame 20 includes a first frame element 24 (e.g., row bar or tool bar) that supports a first disc row 26 and a second frame element 28 (e.g., row or tool bar) that supports a second disc row 30. The disc rows 26, 30 may be referred to as gangs of disc blades. As depicted, the first disc row 26 is located in front of the second disc row 30. Each disc row 26, 30 includes pairs of disc blades 32 each mounted to a single hanging framework via a tandem mount coupled to a mounting bracket 36 as described in greater detail below. The pair of disc blades 32 includes a disc blade 38 axially 14 offset from a disc blade 40 along a longitudinal axis of the tandem mount. In particular, the disc blade 38 is disposed axially 14 closer to a front portion 44 of the implement 10 and the disc blade 40 is disposed axially 14 closer to a rear portion 46 of the implement 10. In certain embodiments, the disc blades 38, 40 may be fluted-concave disc blades.

In certain embodiments, the disc blades 38, 40 may be mounted with a camber to minimize blade to soil backpressure. In certain embodiments, the angle of attack (e.g., angle of blades relative to the direction of travel 12) of the disc blades 38, 40 is configured to be adjusted by an operator (e.g., via linkages coupled to a cylinder). As depicted, the each pair of disc blades 32 in the first disc row 26 are all angled relative to the direction of travel 12 in the lateral direction 16 away from a center line 48 of the implement 10. Each pair of disc blades 32 in the second disc row 30 are angled relative to the direction of travel 12 in the lateral direction 16 toward the center line 48 of the implement 10. The pair of disc blades 32 in the first and second disc rows 26, 30 are indexed with respect to each other so that pair of disc blades 32 in the second disc row 30 operate in the spaces between where the pair of disc blades 32 in the first disc row 26 operate.

The number of pairs of disc blades 32 on a respective frame element may vary (e.g., 2, 3, 4, 5 or more). As depicted, the frame elements 24, 28 each include 3 pairs of disc blades 32. As depicted, disc rows 26, 30 of pairs of disc blades are only illustrated on the portion of the implement 10 to the right of the center line 48. Similarly, the portion of the implement 10 to the left of the center line 48 may include disc rows of tandem mounted pairs of disc blades 32. The number of disc rows on each side of the implement 10 may vary (e.g., 1, 2, 3, or more). As depicted, each side of the implement 10 includes two disc rows (e.g., disc rows 26, 30).

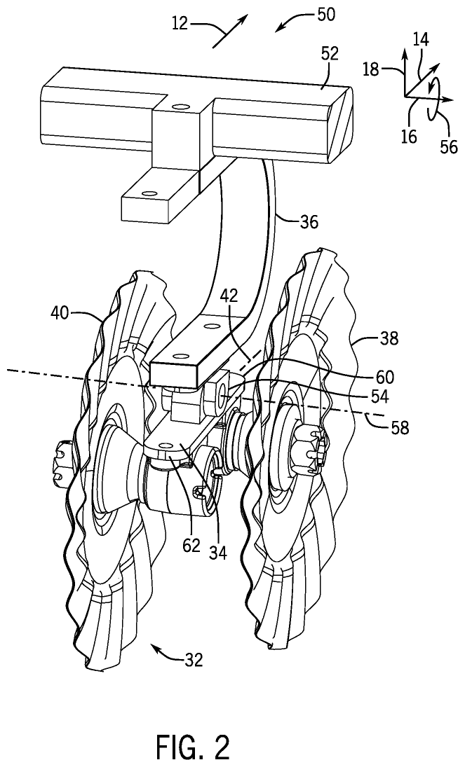

FIG. 2 is a perspective view of an embodiment of a ground working tool 50 (e.g., tandem mounted disc blades). The ground working tool 50 includes the pair of disc blades 32 coupled via a tandem mount 34 to the mounting bracket 36. The mounting bracket 36 is coupled to a frame element segment 52 (e.g., row bar or tool bar segment). The mounting bracket 36 has a curved shape (e.g., C-shape or U-shape) that is configured to deflect to enable up and down movement in the vertical direction 18 relative to the direction of travel 12.

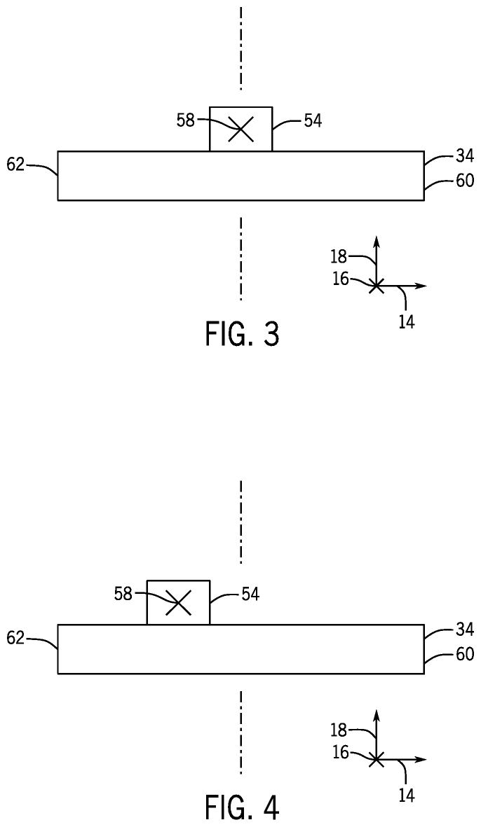

The tandem mount 34 is coupled via a connection point 54 (e.g., bearing assembly) to the mounting bracket 36. The tandem mount 34 (and the pair of disc blades 32) is configured to pivot about the connection point 54 relative to the mounting bracket 36 (e.g., toward and away from the mounting bracket 36). In particular, the tandem mount 34 is configured to pivot in a circumferential direction 56 about a rotational axis 58 of the connection point 54. The rotation axis 58 is orthogonal to a longitudinal axis 42 of the tandem mount 34. As illustrated in FIG. 3, the connection point 54 may be centrally located between a front end 60 (located closer to the front portion 44 of the implement 10 in FIG. 1) and a rear end 62 (located closer to the rear portion 46 of the implement 10 in FIG. 1). Alternatively, as illustrated in FIG. 4, the connection point 54 may be located axially 14 closer to one of the ends 60, 62 (e.g., end 62 closer to where wheel 40 is mounted on the tandem mount 34). Returning to FIG. 2, the connection point 54 is slightly closer to end 62 of the tandem mount 34 than end 60. The pivoting of the tandem mount 34 enables the pair of disc blades 32 to run at the same depth with camber to the soil as the mount is pivoted and the angle of attack adjusted.

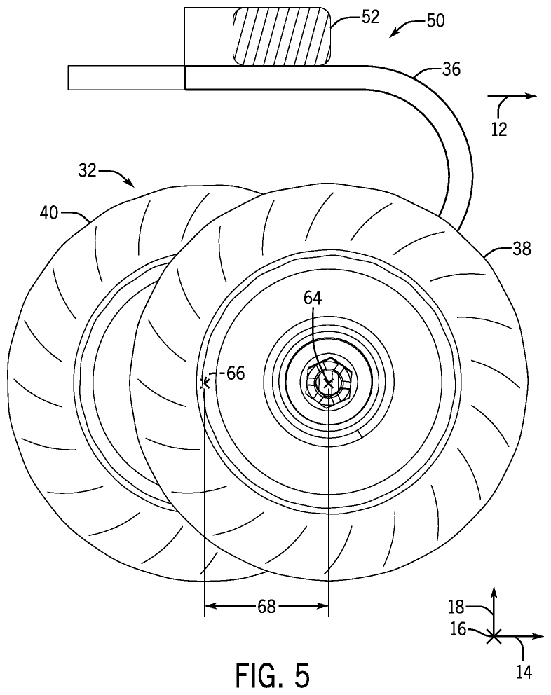

FIG. 5 is a side view of the ground working tool 50 of FIG. 2. As mentioned above, the pairs of disc blades 32 are mounted to the mounting bracket 36 via the tandem mount (e.g., via tandem mount 34 in FIG. 2). The pair of disc blades 32 includes the disc blade 38 axially 14 offset from the disc blade 40 along a longitudinal axis 42 (shown in FIG. 2) of the tandem mount 34. The disc blade 38 includes a rotational axis 64 indicated by an X and the disc blade 40 includes a rotational axis 66 indicated by a dashed X. An axial offset 68 between these rotational axes 64, 66 is greater than 0 and may be up to approximately 25.4 centimeters (10 inches). As shown in FIG. 1, the disc blade 38 is disposed axially 14 closer to the front portion 44 of the implement 10 and the disc blade 40 is disposed axially 14 closer to the rear portion 46 of the implement 10.

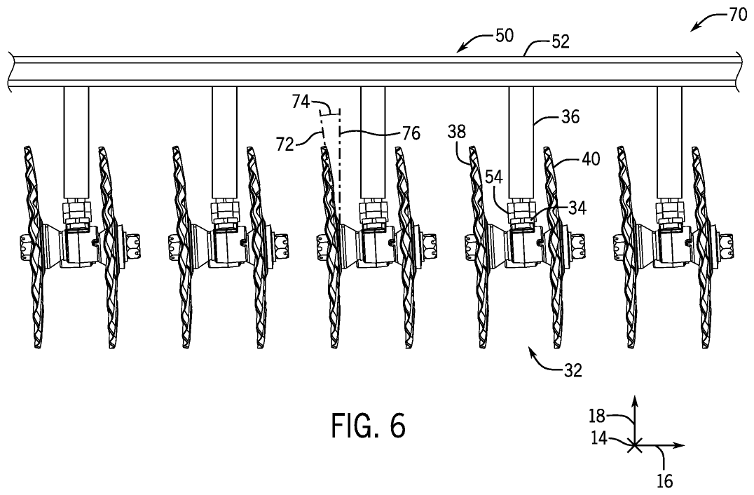

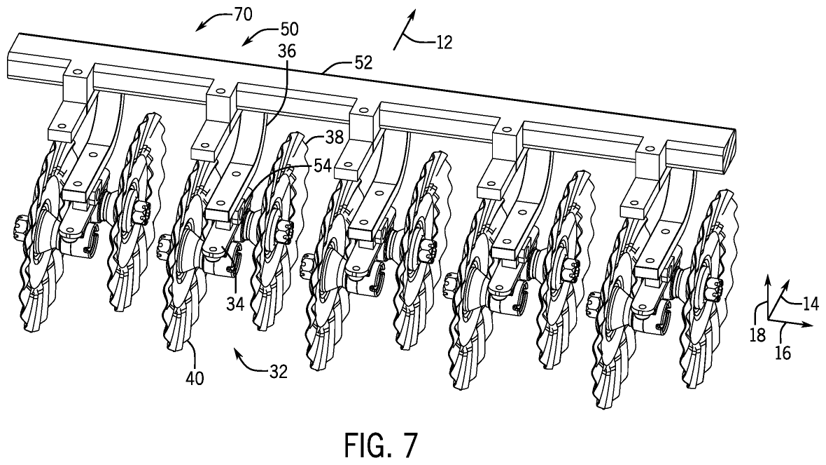

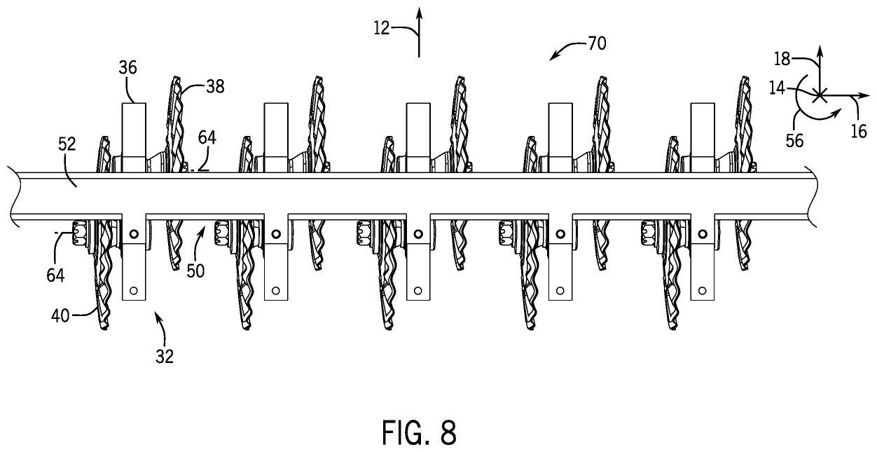

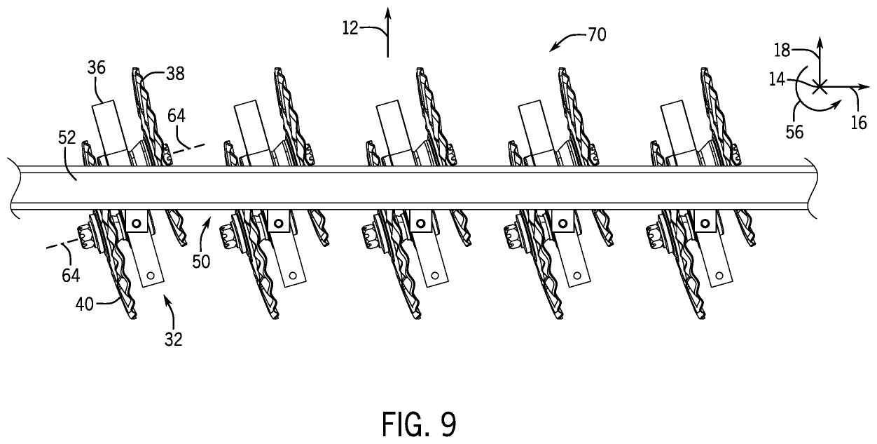

FIGS. 6-9 illustrate different views of a disc row 70. FIG. 6 is a front view of the disc row. FIG. 7 is a rear perspective view of the disc row 70. FIGS. 8 and 9 are top views of the disc row 70. The disc row 70 includes a plurality of the ground working tools 50 described in FIG. 2. As depicted in FIG. 6, a vertical axis 72 of each blade 38, 40 of the pair of blades 32 is disposed at an angle 74 (e.g., camber angle) relative to a vertical axis 76 of the mounting bracket 36. The camber angle 74 minimizes blade to soil backpressure. The camber angle 74 may be greater than 0 and up to approximately ±10 degrees. As depicted in FIG. 6, each blade 38, 40 of the pair of blades 32 has a positive camber relative to the soil that throws soil downward and outward. In certain embodiments, by changing an angle of the respective walking hub pivots each blade 38, 40 is coupled to, each blade 38, 40 of the pair of blades 32 may have a negative camber relative to the soil that throws soil upward and outward.

As depicted in FIGS. 8 and 9, the angle of attack (e.g., angle of blades relative to the direction of travel 12) of the disc blades 38, 40 are configured to be adjusted by an operator (e.g., via linkages coupled to a cylinder). For example, the mounting brackets 36 of the ground working tools 50 may be pivoted in a circumferential direction 56 about the vertical axis 18 relative to the row or tool bar. In FIG. 8, the rotational axes 64, 66 of the disc blades 38, 40 of each pair of disc blades 32 are perpendicular to the direction of travel 12. In FIG. 9, the rotational axes 64, 66 of the disc blades of each pair of disc blades 32 are at an oblique angle relative to the direction of travel 12. The angle of attack may be adjusted between approximately 0 to ±15 degrees relative to the direction of travel 12. Each pair of blades 32 on the disc row 70 may be adjusted simultaneously via the linkages (e.g., coupled to a cylinder).

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A tilling implement, comprising:
a row bar;
a mounting bracket coupled to the row bar; and
a pair of disc blades coupled to the mounting bracket via a tandem mount, wherein the pair of disc blades are axially offset from each other along a longitudinal axis of the tandem mount.

2. The tilling implement of claim 1, wherein the tandem mount is configured to pivot about a connection point relative to the mounting bracket.

3. The tilling implement of claim 2, wherein the tandem mount is configured to pivot in a circumferential direction about a rotational axis of the connection point, wherein the rotational axis is orthogonal to the longitudinal axis.

4. The tilling implement of claim 3, wherein the rotational axis of the connection point is centrally located between where the pair of disc blades are coupled on the tandem mount.

5. The tilling implement of claim 3, wherein the pair of disc blades comprises a first disc blade and a second disc blade, and wherein the rotational axis of the connection point is located closer to where the second disc blade is coupled to the tandem mount than where the first disc blade is coupled to the tandem mount.

6. The tilling implement of claim 5, wherein the first disc blade is coupled to the tandem mount at an axially more forward position relative to a direction of travel of the tilling implement than the second disc blade.

7. The tilling implement of claim 1, wherein the mounting bracket comprises a curve shaped bracket that is configured to deflect to enable movement in a vertical direction relative to a direction of travel of the tilling implement during travel.

8. The tilling implement of claim 1, wherein the pair of disc blades comprises fluted-concave disc blades.

9. The tilling implement of claim 1, wherein a respective vertical axis of each disc blade of the pair of disc blades is cambered at an angle greater than 0 degrees relative to a vertical axis of the mounting bracket to minimize blade to soil backpressure.

10. The tilling implement of claim 1, wherein an angle of the pair of disc blades is configured to be adjusted relative to a direction of travel of the tilling implement.

11. The tilling implement of claim 10, wherein the angle of the pair of disc blades is adjustable between approximately 0 to 15 degrees.

12. The tilling implement of claim 1, comprising a plurality of the mounting brackets coupled to the row bar and a respective pair of disc blades coupled to each mounting bracket of the plurality of mounting brackets via a respective tandem mount, wherein each respective pair of disc blades are axially offset from each other along the longitudinal axis of the respective tandem mount.

13. A ground working implement, comprising:
a row bar;
a plurality of mounting brackets coupled to the row bar; and
a respective pair of disc blades coupled to each mounting bracket of the plurality of mounting brackets via a respective tandem mount, wherein each tandem mount is configured to pivot about a respective connection point with a respective mounting bracket.

14. The ground working implement of claim 13, wherein disc blades of each respective pair of disc blades are axially offset from each other along a longitudinal axis of the respective tandem mount.

15. The ground working implement of claim 14, wherein each respective tandem mount is configured to pivot in a circumferential direction about a rotational axis of the respective connection point, wherein the rotational axis is orthogonal to the longitudinal axis.

16. The ground working implement of claim 15, wherein the rotational axis of the respective connection point is centrally located between where the respective pair of disc blades are coupled on the respective tandem mount.

17. The ground working implement of claim 15, wherein each respective pair of disc blades comprises a first disc blade and a second disc blade, and wherein the rotational axis of the respective connection point is located closer to where the second disc blade is coupled to the respective tandem mount than where the first disc blade is coupled to the respective tandem mount.

18. The ground working implement of claim 13, wherein a respective vertical axis of each disc blade of the respective pair of disc blades is cambered at angle greater than 0 degrees relative to a vertical axis of the respective mounting bracket to minimize blade to soil backpressure.

19. The ground working implement of claim 13, wherein each mounting bracket of the plurality of mounting brackets comprises a curve shaped bracket that is configured to deflect to enable movement in a vertical direction relative to a direction of travel of the tilling implement during travel.

20. A ground working tool configured to be coupled to an implement, comprising:
a mounting bracket;
a tandem mount coupled to the mounting bracket via a pivot joint configured to enable the tandem mount to rotate relative to the mounting bracket; and
a pair of disc blades coupled to the tandem mount, wherein the pair of disc blades are axially offset from each other along a longitudinal axis of the tandem mount.
